(19) United States
(12) Patent Application Publication
(10) Pub. No.: US 2006/0158084 A1
(43) Pub. Date: Jul. 20, 2006

(54) Flat panel display and barrier rib for flat panel display and method of manufacturing the same

(75) Inventor: Myung Won Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/332,156

(22) Filed: Jan. 17, 2006

(30) Foreign Application Priority Data
Jan. 18, 2005 (KR) 10-2005-0004750

(51) Int. Cl. H01J 1/88

(52) U.S. Cl. 313/292

(57) ABSTRACT

This document relates to plasma display device, and more particularly, to a flat panel display, barrier rib for a flat panel display, and method of manufacturing the same. A flat display panel according to an embodiment of the present invention comprises a substrate and a barrier rib that divides pixels on the substrate, whereby the barrier rib comprises a barrier rib paste or slurry comprising a barrier rib material, and the barrier rib paste or slurry comprises a translucent material for exposure light. A barrier rib for flat display panel according to another embodiment of the present invention comprises a barrier rib comprises a barrier rib paste or slurry comprising a barrier rib material, whereby the barrier rib paste or slurry comprises a translucent material for exposure light. A method of manufacturing barrier rib for flat display panel according to still another embodiment of the present invention comprises steps of forming a barrier rib paste layer or slurry layer comprising a translucent material for exposure light on a substrate; exposing the barrier rib paste layer or slurry layer with a prescribed pattern; and etching the barrier rib paste layer or slurry layer.

This Non-provisional application claims priority under 35 U.S.C. §119(a) on Patent Application No. 2005-0004750 filed in Korea on Jan. 18, 2005 the entire contents of which are hereby incorporated by reference.

### BACKGROUND OF THE INVENTION

1. Field of the Invention

This document generally relates to plasma display device, and more particularly, to a flat panel display, barrier rib for a flat panel display, and method of manufacturing the same.

2. Background of the Related Art

A flat display panel comprises different types of display devices, such as liquid crystal display (hereinafter, “LCD”), field emission display (hereinafter, “FED”), organic electroluminescence (hereinafter, “EL”) display, plasma display panel, etc. A plasma display device is a device that displays image by radiation of fluorescent material formed in a display panel, which material is ignited by vacuum ultraviolet rays that are generated when inert gas between a front substrate and a rear substrate, both made of soda-lime glass, is discharged by a high-frequency voltage.

A plasma display panel among such flat display panels has a construction as described below.

Generally, in a plasma display panel, a unit cell is made with barrier rib formed between a front substrate and a rear substrate, whereby the cells are filled up with a main discharge gas such as neon (Ne), helium (He), or a mixture of both (Ne+He), and an inert gas comprising a small quantity of xenon. When a high frequency voltage is discharged, the inert gas generates vacuum ultraviolet rays and an image is displayed by ignition of the fluorescent material formed between the barrier rib. As such plasma display panel allows a thin and light construction, it came into spotlight of the industry as a next generation display device.

In a flat display panel including a plasma display panel of the above construction, a barrier rib is formed for accurate divisions of pixels. Divergent processes of manufacturing such barrier rib are known, among which one process is described below making reference to FIG. 1.

FIG. 1 shows manufacturing process of barrier rib for a plasma display panel in the related art.

First, a dielectric layer 101 is formed on rear substrate 100 on which address electrodes (not shown) are installed, and barrier rib paste or slurry 102 with prescribed thickness made of a mixture of glass material and ceramic type organic material is formed on the dielectric layer 101, by screen printing or by coating, as in step (a).

Then, a photo resist such as dry film photo resist (hereinafter, “DFR”) 103 is formed on the barrier rib paste or slurry 102 by laminating as in step (b), and a photo mask 104 is arrayed over the DFR 103, to undergo a light exposure process.

After the DFR 103 exposure process, a development process is performed as in step (c), in which process DFR 103 of areas not exposed to light (hereinafter, “non-exposed area”) remain on the barrier rib paste or slurry 102, while DFR 103 of areas exposed to light (hereinafter, “exposed area”) is removed by etching.

Then, the barrier rib paste or slurry 102 as well as the DFR 103 undergo an etching process either by sandblast or etching, whereby the parts of barrier rib paste or slurry 102 to become barrier rib are protected by the pattern of DFR 103, and the other parts of barrier rib paste or slurry 102 are removed by etching.

The barrier rib 110 thus formed under protection of the DFR 103 undergoes an exfolication process so that the DFR 103 is removed and the barrier rib paste or slurry 102 is formed as in step (d).

As a result, the barrier rib 110 is completed, discharge spaces are formed between the barrier rib 110, and fluorescent layer (not shown) can be formed by spraying fluorescent materials for R, G, and B.

However, in a related process of forming barrier rib of a plasma display panel, the material cost rises since DFR 103 shall be formed therein after barrier rib paste or slurry 102 has been formed; and the manufacture cost also rises since additional time is required for addition of DFR 103 forming process.

In order to solve such problem of the related art, attempts have been made to shorten the forming process by mixing prescribed photo resist material with barrier rib paste or slurry made of glass material and ceramic type organic material.

However, since a barrier rib paste or slurry made of a mixture of glass material, ceramic type organic material, and prescribed photo resist has a low light transmission factor and worsen exposure characteristics, the thickness of barrier rib to be formed by one exposure process becomes relatively small.

For example, when a related barrier rib paste or slurry made of a mixture of glass material, ceramic type organic material, and prescribed photo resist transmits external light for exposure by a depth of h₁, a total of ten exposure process are required to form barrier rib with a depth of 10 h₁.

As such, in a related process, repeated spraying of barrier rib paste or slurry with a prescribed thickness allowing transmission of light and exposing the same are required, so that the number of processing steps rises and the manufacture time is prolonged, leading to increased manufacture costs.

### SUMMARY OF THE INVENTION

Accordingly, an object of the present invention is to solve at least the problems and disadvantages of the background art.

It is an object of an embodiment of the present invention to provide barrier rib for flat display panel capable of improving exposure characteristics thereof.

A flat display panel according to an embodiment of the present invention comprises a substrate and a barrier rib that divides pixels on the substrate, wherein the barrier rib is formed using a barrier rib paste or slurry comprising a barrier rib material and a translucent material for exposure light.

A barrier rib for flat display panel according to another embodiment of the present invention comprises a barrier rib is formed using a barrier rib paste or slurry comprising a barrier rib material, wherein the barrier rib paste or slurry comprises a translucent material for exposure light.

A method of manufacturing barrier rib for flat display panel according to still another embodiment of the present invention comprises steps of forming a barrier rib paste layer or slurry layer comprising a translucent material for exposure light on a substrate; exposing the barrier rib paste layer or slurry layer with a prescribed pattern; and etching the barrier rib paste layer or slurry layer.

In accordance with an embodiment of the present invention can provide fine pitch barrier rib by improving exposure characteristics in an exposure process through formation of barrier rib with barrier rib paste or slurry that comprises predetermined translucent material for exposure light

In accordance with an embodiment of the present invention can reduce manufacture costs by reducing the process of manufacturing barrier rib

### BRIEF DESCRIPTION OF THE DRAWINGS

The embodiment of the invention will be described in detail with reference to the following drawings in which like numerals refer to like elements.

FIG. 1 shows manufacturing process of barrier rib for a plasma display panel in the related art.

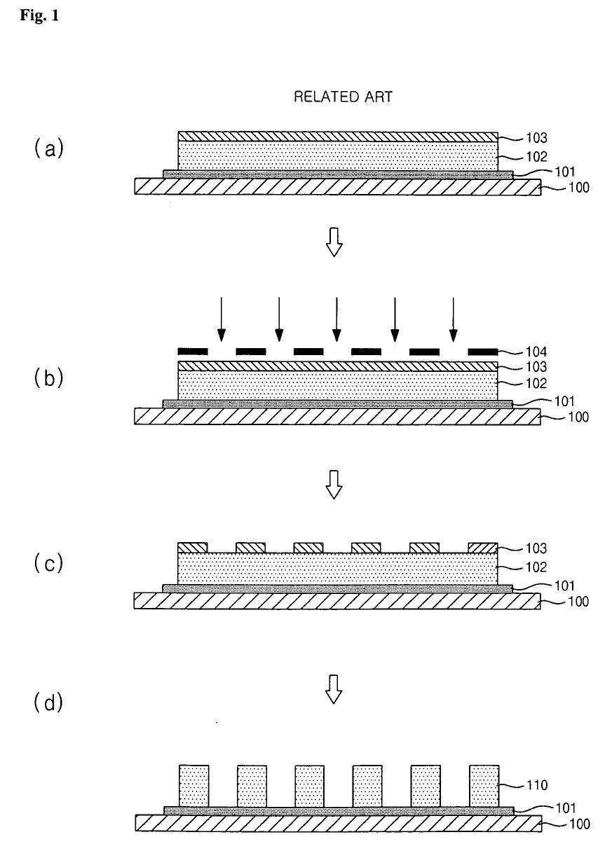

FIG. 2 is a view illustrating the structure of a plasma display panel among flat display panels according to an embodiment of the present invention.

FIG. 3 is a view illustrating a barrier rib for flat display panel according to an embodiment of the present invention.

FIG. 4 shows views describing light transmission by optical fiber comprised in the barrier rib paste or slurry used for manufacturing a barrier rib for flat display panel according to an embodiment of the present invention.

FIG. 5 is a view illustrating an example of manufacturing process of a barrier rib for flat display panel according to an embodiment of the present invention.

FIG. 6 is a detail view of area B of step (b) in FIG. 5.

### DETAILED DESCRIPTION OF PREFERRED EMBODIMENTS

Embodiments of the present invention will be described in a more detailed manner with reference to the drawings.

A flat display panel according to an embodiment of the present invention comprises a substrate and a barrier rib that divides pixels on the substrate, wherein the barrier rib is formed using a barrier rib paste or slurry comprising a barrier rib material and a translucent material for exposure light.

The translucent material for exposure light comprises an optical fiber.

The optical fiber has a predetermined refraction ratio, and comprises an internal core part for transmitting exposure light radiated from the outside and a clad part having a refraction ratio different from the refraction ratio of the core part, for enabling the total reflection of the exposure light within the core part.

The length of the optical fiber is 1 μm to 200 μm.

The optical fiber is 20 wt % to 50 wt % of the total weight of the barrier rib paste.

A barrier rib for flat display panel according to an embodiment of the present invention comprises a barrier rib is formed using a barrier rib paste or slurry comprising a barrier rib material, whereby the barrier rib paste or slurry comprises a translucent material for exposure light

The translucent material for exposure light comprises an optical fiber.

The optical fiber has a predetermined refraction ratio, and comprises an internal core part for transmitting exposure light radiated from the outside and a clad part having a refraction ratio different from the refraction ratio of the core part, for enabling the total reflection of the exposure light within the core part. The length of the optical fiber is 1 μm to 200 μm.

The optical fiber is 20 wt % to 50 wt % of the total weight of the barrier rib paste.

A method of manufacturing barrier rib for flat display panel according to an embodiment of the present invention comprises steps of forming a barrier rib paste or slurry layer comprising a translucent material for exposure light on a substrate; exposing the barrier rib paste or slurry layer with a prescribed pattern; and etching the barrier rib paste or slurry layer

The translucent material for exposure light comprises an optical fiber.

The optical fiber has a predetermined refraction ratio, and comprises an internal core part for transmitting exposure light radiated from the outside and a clad part having a refraction ratio different from the refraction ratio of the core part, for enabling the total reflection of the exposure light within the core part.

The length of the optical fiber is 1 μm to 200 μm.

The optical fiber is 20 wt % to 50 wt % of the total weight of the barrier rib paste.

An embodiment of the present invention will be described below with reference to the accompanying drawings.

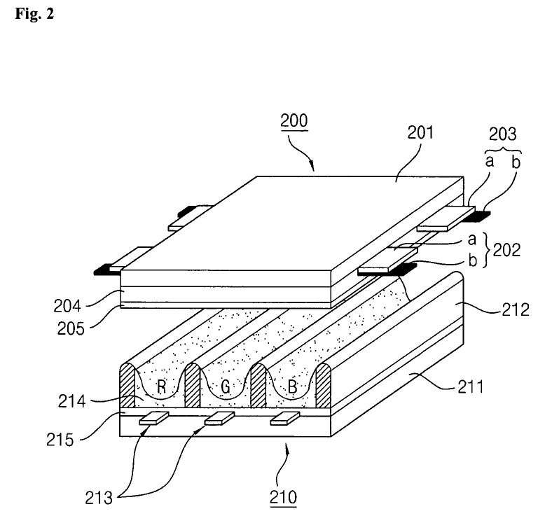

FIG. 2 is a view illustrating the structure of a plasma display panel among flat display panels according to an embodiment of the present invention.

As shown in FIG. 2, a plasma display panel is formed by combining a front substrate 211 and a rear substrate 210 in parallel to each other with a predetermined distance, the front substrate 211 comprising a plurality of maintenance electrode pairs consisted of a pair each of scan electrode 202 and sustain electrode 203 installed on a front glass 211 on which image is displayed, and the rear substrate 210 comprising a plurality of address electrodes 213 installed on a rear glass 211 which forms rear surface (of the display panel) in a manner that the address electrodes 213 cross the above plurality of maintenance electrode pairs.

The front substrate 200 comprises a pair each of scan electrode 202 and sustain electrode 203 for discharging mutually in a discharge cell and maintaining radiation in the cell, whereby each electrode comprises a transparent electrode (a) comprising a transparent ITO material and of a bus electrode (b) comprising a metal.

The scan electrode 202 and the sustain electrode 203 are covered by at least one dielectric layer 204 that limits discharge current and insulates between the electrode pairs, and a protective layer 205 with magnesium oxide (MgO) is formed on the upper dielectric layer 204 for ease of discharging.

The rear substrate 210 comprises a plurality of discharge spaces, i.e. barrier rib 212 in stripe form (or well form) are installed in parallel. And a plurality of address electrodes 213 that perform address discharge to generate vacuum ultraviolet rays is installed parallel to the barrier rib 212.

On upper surface of the rear substrate 210, fluorescent materials 214 for R, G, B capable of emitting visible rays for display of images at the time of address discharge are sprayed. Between the address electrodes 213 and the fluorescent materials 214 a lower dielectric layer 215 is formed to protect the address electrodes 213.

On a flat display panel comprising a plasma display panel of the above construction barrier rib 212 are formed to accurately divide the pixels.

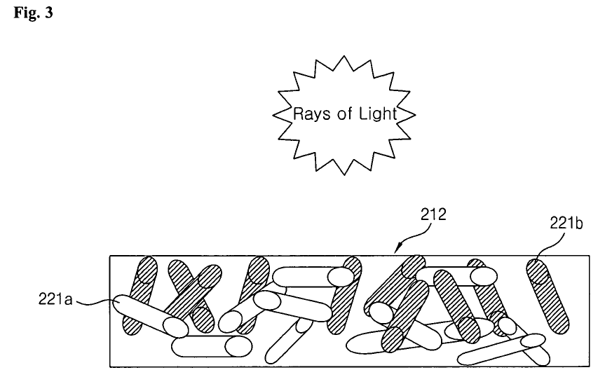

FIG. 3 is a view illustrating a barrier rib for flat display panel according to an embodiment of the present invention.

As shown in FIG. 3, a barrier rib for flat display panel according to an embodiment of the present invention comprises a translucent material for exposure light, preferably, optical fiber.

Considering that barrier rib 212 for flat display panel according to an embodiment of the present invention is formed a barrier rib paste or slurry state, the above statement that barrier rib 212 for flat display panel comprises predetermined translucent material for exposure light, can be understood that the barrier rib paste or slurry for flat display panel comprises the predetermined translucent material for exposure light, whereby the barrier rib paste or slurry for flat display panel comprises already predetermined organic material, etc.

The optical fiber is distributed in the barrier rib paste or slurry to direct divergent directions. For, example, the optical fiber 221a is oriented to a direction that does not allow transmission of exposure light into an effective angle of incidence, while the optical fiber 221b is oriented to a direction that allows exposure light to be transmitted into the effective angle of incidence.

The optical fibers oriented to a direction same as the optical fiber 221b transmit light entering into the barrier rib paste or slurry with a predetermined angle of incidence by totally reflecting the light without any refraction.

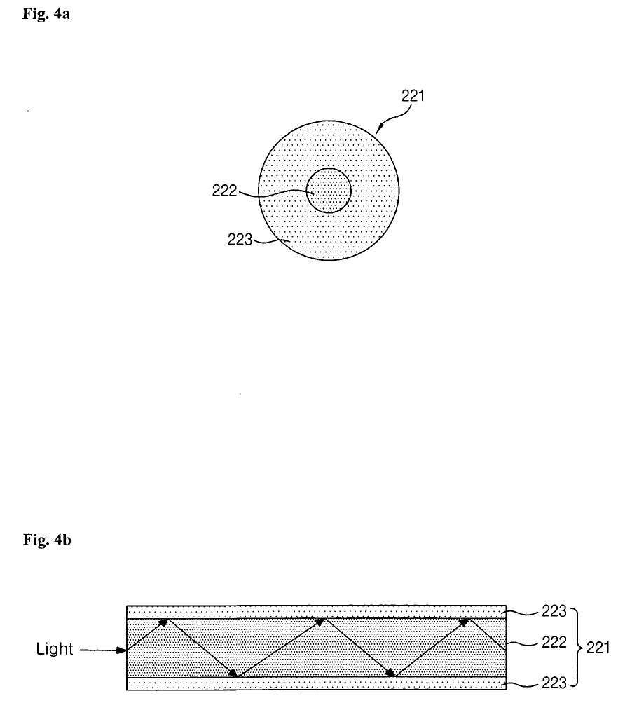

A more detailed description of light transmission by the optical fiber comprised the barrier rib paste or slurry for flat display panel is given in FIGS. 4a and 4b.

FIGS. 4a and 4b shows views describing light transmission by optical fiber comprised in the barrier rib paste or slurry used for manufacturing a barrier rib for flat display panel according to an embodiment of the present invention.

As shown in FIG. 4a which depicts a cross-sectional view of the optical fiber 221, the optical fiber 221 is comprised a core part 222 that transmits light ray and a clad part 223 having a refraction ratio different from that of the core part 222 to enable the total reflection of the light ray. Generally, transmission of light which is performed by reflections and refractions of the light, is determined by angle of incidence and refraction ratio of different media through which the light ray passes. Transmission process of light by optical fiber 221, comprising a core part 222 and a clad part 223 with different refraction ratio is described in FIG. 4b.

As shown in FIG. 4b, if a ray of light entered into the core part 222 emerges to a joint surface of the clad part 223 at an angle larger than a predetermined critical angle, the ray is reflected at an angle same as the angle of incidence.

Where ray of light enters a boundary between two media of uneven refraction ratios from a medium with a higher refraction ratio to one with a lower refraction ratio at a given angle of incidence, the ray of light is transmitted by the total reflection without being refracted, when the angle of incidence reaches a critical angle. If the refraction ratio of the clad part 223 is set to be 1% lower than the refraction ratio of the core part 222, e.g. the core part 222 has the refraction ratio of 1.47 while the clad part 223 has a refraction ratio of 1.46, the total reflection can be achieved.

As such, ray of light in core part 222 of an optical fiber 221 can effectively be transmitted to a relatively far distance utilizing this total reflection phenomenon.

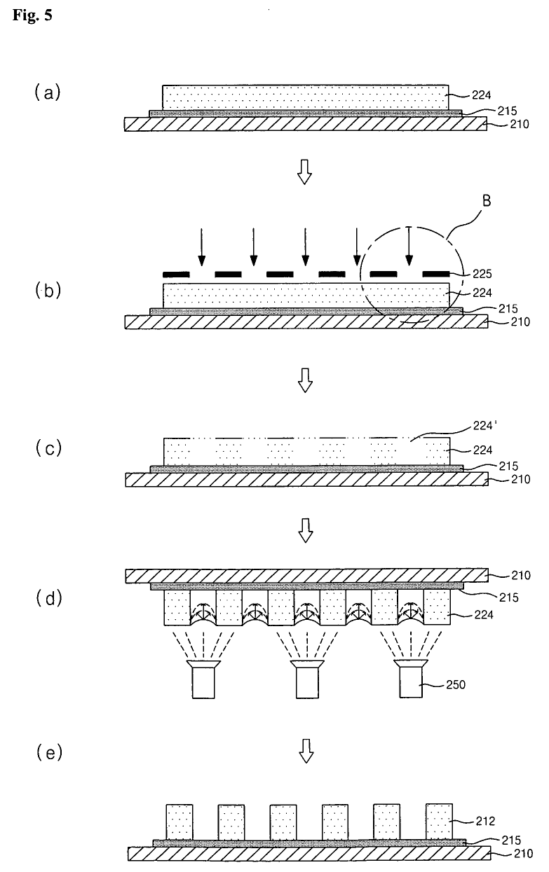

An example of manufacturing process of barrier rib for flat display panel utilizing a barrier rib paste or slurry comprising optical fiber for the purpose of dividing pixels in accordance with external exposure light is described in FIG. 5.

FIG. 5 is a view illustrating an example of manufacturing process of a barrier rib for flat display panel according to an embodiment of the present invention.

In the manufacturing process of a barrier rib for a plasma display panel as an example of manufacturing process of a flat display panel, a barrier rib paste or slurry layer comprising prescribed translucent material for exposure light is formed first at predetermined position. For example, a dielectric layer 215 is formed on a lower substrate 210 equipped with address electrodes (not shown) as in step (a), and a barrier rib paste or slurry 224 comprising a translucent material for exposure light is formed with a prescribed thickness on the dielectric layer 215.

Here, the translucent material for exposure light is a optical fiber, whereby the optical fiber has a predetermined refraction ratio, and comprises an internal core part for transmitting exposure light radiated from the outside and a clad part having a refraction ratio different from the refraction ratio of the core, for enabling the total reflection of the exposure light within the core part.

The length of the optical fiber may be 1 μm to 200 μm, while the optical fiber may be 20 wt % to 50 wt % of the total weight of the barrier rib paste.

The reason for limiting the length and content of the barrier rib paste or slurry 224 as above is as follows.

Firstly, the reason for limiting the length of the optical fiber to be comprised the barrier rib paste or slurry 224 on or over 1 μm is that, if the optical fiber is excessively short, i.e. shorter than 1 μm, a sufficiently deep light transmission by optical fiber within the barrier rib paste or slurry 224 can hardly be secured.

The reason for limiting the length of optical fiber to be comprised the barrier rib paste or slurry 224 on or lower than 200 μm is that, if the optical fiber is excessively long, the optical fiber cannot be mixed in the barrier rib paste or slurry 224 properly and can even extrude out of the barrier rib after the barrier rib are formed.

Further, the reason for limiting the optical fiber to be comprised the barrier rib paste or slurry 224 on or over 20 wt % of the total weight of the barrier rib paste or slurry 224 is that, if the optical fiber is comprised less than 20 wt %, the optical fiber cannot be distributed sufficiently in the barrier rib paste or slurry and the light transmission ratio will be lowered.

Finally, the reason for limiting the optical fiber to be comprised the barrier rib paste or slurry 224 on or lower than 50 wt % of the total weight of the barrier rib paste or slurry 224 is that, if the optical fiber is comprised over 50 wt %, the optical fiber comprised excessively the barrier rib paste or slurry 224 can deteriorate peculiar characteristics of the barrier rib.

The barrier rib paste or slurry 224 can be formed through any one process of screen printing, laminating, or coating.

After the above process of forming a barrier rib paste layer or slurry layer, an exposure process is performed as in (b) to expose the barrier rib paste or slurry 224 with a prescribed pattern, by exposing the barrier rib paste or slurry 224 that comprises optical fiber after photo masks 225 have been arrayed on the barrier rib paste or slurry 224. Subsequently, a development process is performed.

Through the development process as in (c), barrier rib paste or slurry 224 of areas not exposed to light (hereinafter, “non-exposed areas”) is hardened, while barrier rib paste or slurry 224 of areas exposed to light (hereinafter, “exposed areas”) is softened.

After that, an etching process as in (d) is performed, wherein etching liquid is sprayed on the barrier rib paste or slurry 224 from an etching device 250 installed over the barrier rib paste or slurry 224. The hardened barrier rib paste or slurry 224, for instance, is protected hereby, while the softened barrier rib paste or slurry 224 is removed by etching, so that barrier rib 212 are completed as in (e), forming concave discharge spaces between the barrier rib 212 to allow formation of a fluorescent layer 214 by spraying fluorescent materials for R, G, B in the discharge spaces.

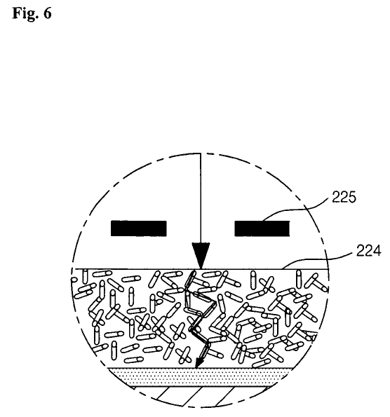

In the above manufacturing process of barrier rib for plasma display panel as an example of manufacturing process of barrier rib for flat display panel a more detail description of area B in step (b) is depicted in FIG. 6.

FIG. 6 is a detail view of area B of step (b) in FIG. 5.

As shown in FIG. 6, in the above step (b) in FIG. 5, the barrier rib paste or slurry 224 with photo mask 225 arrayed thereon is not exposed, while the barrier rib paste or slurry 224 with no photo mask 225 arrayed thereon is exposed.

As ray of light entering the barrier rib paste or slurry 224 comprised the optical fibers can reach deep into the barrier rib paste or slurry 224 by the total reflection, the exposure characteristics of the barrier rib paste or slurry 224 can be improved.

Therefore, the thickness of the barrier rib to be formed by one exposure process in formation of the barrier rib can also increase in comparison to the related art.

For example, if the depth of the barrier rib paste or slurry to which exposure light can reach in one exposure process in related art is h₁, and the corresponding depth in FIG. 6 is h₂, an inequality, h₁<h₂ is established.

In other words, ten exposure processes were required in related art to form barrier rib with a depth of 10 h₁. However, the barrier rib of a desired depth can be formed in FIG. 6 through a smaller number of exposure processes than in the related air e.g. through a total of 1 processes.

Thus, an embodiment of the present invention can reduce the number of processes required for forming barrier rib.

Furthermore, since an embodiment of the present invention allows to form barrier rib with a greater depth in comparison to related art, it can embody fine pitch the barrier rib.

For example, supposing that barrier rib of a desired thickness is formed through ten exposure processes, and the same is formed through one exposure processes in FIG. 6, widening of the width of barrier rib is required to cover errors to be possibly generated in repeated arraying of photo masks during the ten times exposure processes in the related art.

Accordingly, the barrier rib with a width bigger than the desired width is formed in the related art. In contrast thereto, as the width of the barrier rib are controlled by considering only possible errors for one time of exposure processes in FIG. 6, the width of the barrier rib can remain smaller than the width of the barrier rib of the related art.

Due to these reasons, a flat display panel according to an embodiment of the present invention can embody fine pitch barrier rib.

This document as described above, by forming the barrier rib with the barrier rib paste or slurry comprising prescribed the translucent material for exposure light, can provide fine pitch the barrier rib through improvement of exposure characteristics of the barrier rib in the exposure processes.

Furthermore, this document can reduce manufacture costs by reducing manufacture process of the barrier rib.

The invention being thus described, it will be obvious that the same may be varied in many ways. Such variations are not to be regarded as a departure from the spirit and scope of the invention, and such modifications as would be obvious to one skilled in the art are intended to be included within the scope of the following claims.

What is claimed is:

1. A flat display panel comprising:
a substrate; and
a barrier rib that divides pixels on the substrate,
wherein the barrier rib is formed using a barrier rib paste or slurry comprising a barrier rib material and a translucent material for exposure light.

2. The flat display panel as claimed in claim 1, wherein the translucent material for exposure light comprises an optical fiber.

3. The flat display panel as claimed in claim 2, wherein the optical fiber has a predetermined refraction ratio, and comprises an internal core part for transmitting exposure light radiated from the outside and a clad part having a refraction ratio different from the refraction ratio of the core part, for enabling the total reflection of the exposure light within the core part.

4. The flat display panel as claimed in claim 3, wherein the length of the optical fiber is 1 μm to 200 μm.

5. The flat display panel as claimed in claim 4, wherein the optical fiber is 20 wt % to 5 wt % of the total weight of the barrier rib paste or slurry.

6. A barrier rib for flat display panel comprising:
a barrier rib is formed using a barrier rib paste or slurry comprising a barrier rib material, wherein the barrier rib paste or slurry comprises a translucent material for exposure light.

7. The barrier rib for flat display panel as claimed in claim 6, wherein the translucent material for exposure light comprises an optical fiber.

8. The barrier rib for flat display panel as claimed in claim 7, wherein the optical fiber has a predetermined refraction ratio, and comprises an internal core part for transmitting exposure light radiated from the outside and a clad part having a refraction ratio different from the refraction ratio of the core part, for enabling the total reflection of the exposure light within the core part.

9. The barrier rib for a flat display panel as claimed in claim 8, wherein the length of the optical fiber is 1 μm to 200 μm.

10. The barrier rib for flat display panel as claimed in claim 8, wherein the optical fiber is 20 wt % to 50 wt % of the total weight of the barrier rib paste.

11. A method of manufacturing barrier rib for flat display panel comprising the steps of:
forming a barrier rib paste layer or slurry layer comprising a translucent material for exposure light on a substrate;
exposing the barrier rib paste layer or slurry layer with a predetermined pattern; and
etching the barrier rib paste layer or slurry layer.

12. The method of manufacturing barrier rib for flat display panel as claimed in claim 11, wherein the exposing of the barrier rib paste layer or slurry layer is performed one time.

13. The method of manufacturing barrier rib for flat display panel as claimed in claim 11, the translucent material for exposure light comprises an optical fiber.

14. The method of manufacturing barrier rib for flat display panel as claimed in claim 13, wherein the optical fiber has a predetermined refraction ratio, and comprises an internal core part for transmitting exposure light radiated from the outside and a clad part having a refraction ratio different from the refraction ratio of the core part for enabling the total reflection of the exposure light within the core part.

15. The method of manufacturing barrier rib for flat display panel as claimed in claim 14, wherein the length of the optical fiber is 1 μm to 200 μm.

16. The method of manufacturing barrier rib for flat display panel as claimed in claim 15, wherein the optical fiber is 20 wt % to 50 wt % of the total weight of the barrier rib paste or slurry.
